(19) United States
(12) Patent Application Publication
(10) Pub. No.: US 2010/0038368 A1
(43) Pub. Date: Feb. 18, 2010

(54) Infinite Wisdom Mug

(76) Inventor: Colleen L. Larreau, Las Vegas, NV (US)

Correspondence Address: COLLEEN LARREAU, 10729 CHILLINGHAM DR., LAS VEGAS, NV, 89183, US

(21) Appl. No.: 12/321,426

(22) Filed: Jan. 20, 2009

Related U.S. Application Data
(60) Provisional application No. 61/064,838, filed on Mar. 26, 2008.

(51) Int. Cl. A47J 41/00

(52) U.S. Cl. 220/592.17

(57) ABSTRACT

This invention is a new and improved design is for a travel mug or thermos. It has a REMOVABLE liquid containment vessel (liner) that is both microwave safe, dishwasher safe, and can be made from traditional or soy plastics. A specially designed locking mechanism firmly secures the liner in place when the mug or thermos is in use.

### CROSS-REFERENCE TO RELATED APPLICATIONS

I currently hold a provisional license with application No. 61/064,838 expiring on Mar. 26, 2009.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUNDOF THE INVENTION

This invention is a household appliance and convenience item. This invention addresses specific problems involved in prior products. Standard travel mugs or thermoses may contain metal and layers of insulation. These substances work great for retaining heat, but are not microwave or dishwasher safe. In addition, if liquid contents are transferred to microwavable containers for reheating and back into a travel mug or thermos when hot, a burn injury is quite possible.

### BRIEF SUMMARY OF THE INVENTION

This invention is a dramatically improved version of a travel mug or thermos. This invention has a removable plastic or soy plastic liquid containment vessel (liner) that is safe for the microwave and the dishwasher. The ability to remove the liner and place it safely into the microwave is convenient and reduces burn injury. The removal of the liner has an added convenience of being dishwasher safe for easy cleaning and sanitizing.

### BRIEF DESCRIPTION OF THE SEVERAL VIEWS OF THE DRAWING

FIG. 1A: Full view of intact mug

FIG. 1B: View of intact mug with all layers visible

FIG. 2A: View of removable liner detached from mug

FIG. 3A: View of the locking mechanism

FIG. 4A: View of lid-top view

FIG. 4B: View of lid-side view

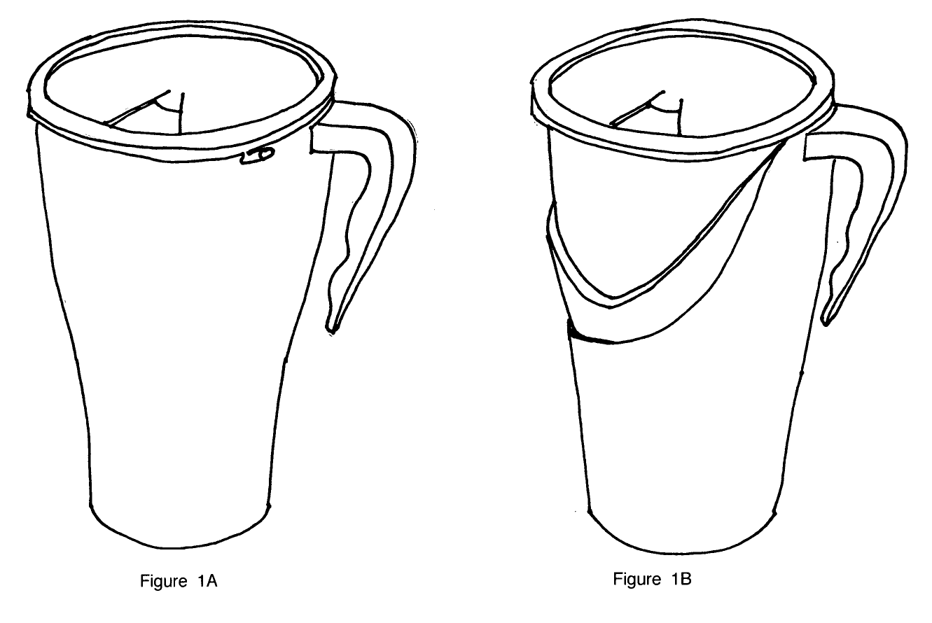

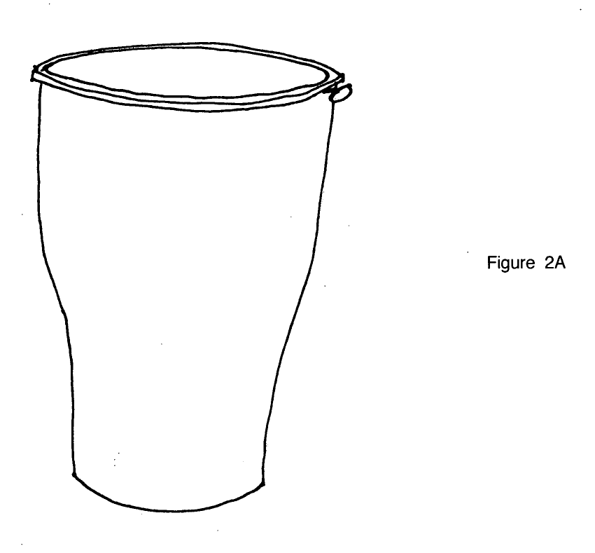

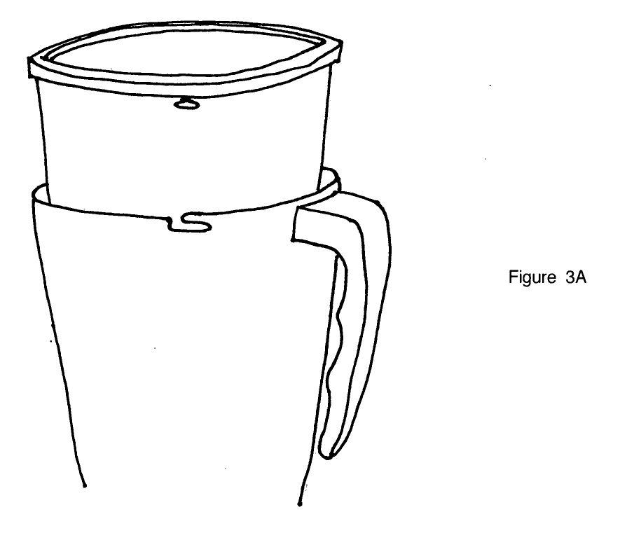

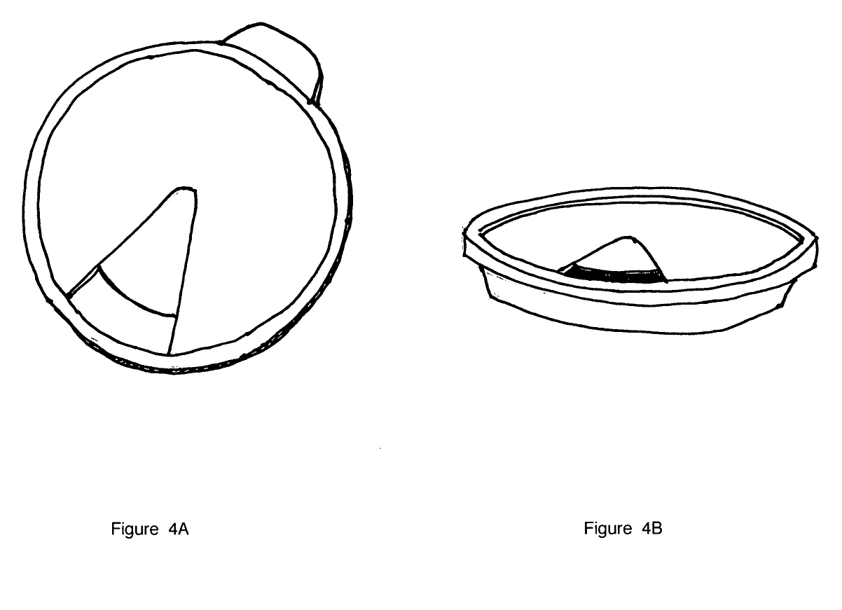

### DETAILED DESCRIPTIONOF THE INVENTION

This invention is of an insulated travel mug or thermos for liquids. This invention has three layers. The outer, and visible shell of the container is made of metal. Metal helps retain the desired temperature for longer.

The inner-most layer, designed for holding the liquid contents of the mug, is made of plastic or soy plastic. This plastic liner is REMOVABLE. This liner is constructed with an “easy grip lip” so as to make gripping the liner for the removal process easy and safe. This lip is a thickened band of plastic around the top of the liner. This invention is also constructed with a locking mechanism to assure the liner remains in place until removal is desired. Twist the plastic liner slightly to the left and the male mechanism lines up with the female slot, and lifts right out. This removable liner is both dishwasher safe, and microwavable. Because this removable inner layer is microwavable, the transferring of re-heated liquids between microwavable containers is eliminated, and reduces the risk of a burn injury.

The middle layer, between the outer metal shell and removable liner, is a layer of insulation sealed in plastic. The insulation and seal can also be made with soy products.

This invention can also be equipped with a nice plastic handle, and a lid with a pour spout that can open and close to reduce spilling and leaking.

This travel mug or thermos stands separate from the traditional and numerous models because it is the only one with a REMOVABLE liner that is microwavable and dishwasher safe. The insulation in other models makes them incapable of being placed in a dishwasher. The metal and steel make the other models incapable of being placed in a microwave. This invention solves each of these problems. The plastic or soy plastic liner in this invention is simply removed and popped into the microwave for re-heating, or into the dishwasher for cleaning and sanitizing. The ability to place this liner into the microwave without having to pour the contents into a microwavable container and back into the travel mug or thermos reduces the risk of burn injury.

1. This is a claim to any travel mug with a removable liquid containment vessel (liner).
Liner is plastic
Alternative plastics can be used
Liner is microwave safe
Liner is dishwasher safe
Liner has a safety locking mechanism
Option for insulation between outer shell and removable liner
Alternative insulations can be used
Option for a handle on the mug
Mug may vary in size

2. This is a claim to any alternative thermos style container with a removable liquid containment vessel (liner).
Liner is plastic
Alternative plastics can be used
Liner is microwave safe
Liner is dishwasher safe
Liner has a safety locking mechanism
Option for insulation between outer shell and removable liner
Alternative insulations can be used
Option for a handle on the thermos
Thermos may vary in size
